(19) United States
(12) Patent Application Publication
(10) Pub. No.: US 2010/0001910 A1
(43) Pub. Date: Jan. 7, 2010

(54) On-Vehicle Antenna

(75) Inventors: Shinobu Kawaguchi, Warabi-shi (JP); Motoki Ohshima, Warabi-shi (JP); Hitoshi Morita, Warabi-shi (JP)

Correspondence Address: OLIFF & BERRIDGE, PLC, P.O. BOX 320850, ALEXANDRIA, VA, 22320-4850, US

(73) Assignee: NIPPON ANTENA KABUSHIKI KAISHA, Arakawa-ku (JP)

(21) Appl. No.: 11/573,345

(22) PCT Filed: Jan. 24, 2006
(86) PCT No.: PCT/JP2006/301020

§ 371 Date: Feb. 6, 2007

(30) Foreign Application Priority Data
Mar. 25, 2005 (JP) 2005-088045

(51) Int. Cl. H01Q 1/38; H01Q 1/32

(52) U.S. Cl. 343/711; 343/700 MS

(57) ABSTRACT

No coupled effects occur even when a plurality of antennas is provided. An insert fitting 12 is formed integrally with an antenna cover such that the insert fitting 12 is arranged overhead of a patch antenna 13 in a position where the gap h satisfies h<<λ/4. Further, the width D of the insert fitting 12 and an antenna element 10 secured to the insert fitting 12 is set so as to satisfy D<<λ/4, and the insert fitting 12 and the antenna element 10 are extended upwards at a slant. An effect on the emission pattern and electric characteristics of the patch antenna 13 can thereby be prevented even if the antenna element 10 and the insert fitting 12, which are metal conductors, are arranged in proximity to the patch antenna 13.

### TECHNICAL FIELD

The present invention relates to a vehicular antenna comprising a plurality of antennas that operate on differing use frequencies.

### BACKGROUND ART

A variety of antennas are used as antennas installed on vehicles, but in the past it was preferable to install roof antennas on the roof because installing the antenna on the roof, which is the highest location on the vehicle, can heighten the reception sensitivity. Moreover, FM radios and AM radios are generally provided in the vehicle, and therefore roof antennas that can receive two radio bands have been popular because antennas that can receive both the FM radio band and the AM radio band are convenient. In addition, car navigation systems that use GPS (global position system) and mobile wireless telephones have become widespread. GPS antennas are installed in car navigation systems, and mobile wireless telephone antennas are installed in vehicles for portable wireless telephones. Installing all these various antennas independently on the vehicle is not only unsightly but also maintenance and installation operations or the like are complicated, and therefore, multi-frequency antennas that receive the FM radio band, the AM radio band and the GPS band or the like by a single antenna, are well known (see Japanese Publication Unexamined Patent Application No. H10-933327).

### DISCLOSURE OF THE INVENTION

### Problem that the Invention is Intended to Solve

In this regard, mutual coupling is electromagnetically produced between antenna elements of multi-frequency antennas that comprise a plurality of antennas, and has an effect of the emission pattern. Impedance and capacitance produced between antenna elements by mutually coupling become parameters that determine the impedance and load on the various antenna elements. For this reason, multi-frequency antennas comprising a plurality of antennas have the problem that the various antenna elements are affected by the electric characteristics of the other antenna elements.

Thus, an object of the present invention is to provide a vehicle antenna in which there is no mutual effect even when comprising a plurality of antennas.

### Means for Solving the Problem

In order to achieve the aforementioned object, the major characteristics of the vehicular antenna of the present invention are that a lead wire that leads the antenna element signals is connected to a first substrate that handles the signals that are received by the antenna element through substantially the center of a patch antenna, and that an insert fitting in which the antenna element is fixed is arranged in the overhead area of the patch antenna that does not affect the patch antenna emission pattern.

### EFFECT OF THE INVENTION

According to the present invention, because the lead wire that leads the antenna element signals is connected to a first substrate that handles the signals that are received by the antenna element through substantially the center of a patch antenna, and because the insert fitting in which the antenna element is fixed is arranged in the overhead area of the patch antenna that does not affect the patch antenna emission pattern, there is no strong electromagnetic mutual coupling between the antenna elements and the insert fitting with the patch antenna. For this reason, it becomes possible to prevent the antenna elements and the insert fitting from having an effect on the emission pattern and impedance of the patch antenna.

### BRIEF DESCRIPTION OF THE DRAWINGS

FIG. 1 is a cross-sectional diagram viewed from the side indicating a configuration of a vehicular antenna of an embodiment of the present invention;

FIG. 2 is a side view diagram with a part of a vehicular antenna of an embodiment of the present invention indicated transparently;

FIG. 3 is an analytic assembly diagram of a vehicular antenna of an embodiment of the present invention;

FIG. 4 is a diagram indicating the configuration of a first substrate of a vehicular antenna of an embodiment of the present invention;

FIG. 5 is a diagram indicating the configuration of the back side of a second substrate of a vehicular antenna of an embodiment of the present invention;

FIG. 6 is a diagram indicating the configuration of the front side of a second substrate of a vehicular antenna of an embodiment of the present invention;

FIG. 7 is a diagram indicating the outline of the emission field of a patch antenna for explaining the characteristic configuration of a vehicular antenna of the present invention;

FIG. 8 is diagram for explaining the arrangement of the characteristic insert fitting and antenna element of a vehicular antenna of the present invention;

FIG. 9 is a diagram indicating the schema of a measurement system to measure the orientation characteristics in a transverse plane of a vehicular antenna related to the present invention;

FIG. 10 is a diagram indicating the orientation characteristics in the transverse plane with an elevation angle θ=20° of a vehicular antenna related to the present invention;

FIG. 11 is a diagram indicating the orientation characteristics in the transverse plane with an elevation angle θ=25° of a vehicular antenna related to the present invention;

FIG. 12 is a diagram indicating the orientation characteristics in the transverse plane with an elevation angle θ=30° of a vehicular antenna related to the present invention;

FIG. 13 is a diagram indicating the orientation characteristics in the transverse plane with an elevation angle θ=35° of a vehicular antenna related to the present invention;

FIG. 14 is a diagram indicating the orientation characteristics in the transverse plane with an elevation angle θ=40° of a vehicular antenna related to the present invention;

FIG. 15 is a diagram indicating the orientation characteristics in the transverse plane with an elevation angle θ=45° of a vehicular antenna related to the present invention;

FIG. 16 is a diagram indicating the orientation characteristics in the transverse plane with an elevation angle θ=50° of a vehicular antenna related to the present invention;

FIG. 17 is a diagram indicating the orientation characteristics in the transverse plane with an elevation angle θ=55° of a vehicular antenna related to the present invention;

FIG. 18 is a diagram indicating the orientation characteristics in the transverse plane with an elevation angle θ=60° of a vehicular antenna related to the present invention;

FIG. 19 is a table indicating the changes of the average gain (Ave.) and minimum gain (Min.) when varying the elevation angle θ of a vehicular antenna related to the present invention in a range from 20° to 60°;

FIG. 20 is a graph indicating the changes in average gain (Ave.) when varying the elevation angle θ of a vehicular antenna related to the present invention in a range from 20° to 60°; and

FIG. 21 is a graph indicating the changes in minimum gain (Min.) when varying the elevation angle θ of a vehicular antenna related to the present invention in a range from 20° to 60°.

### BEST MODE FOR CARRYING OUT THE INVENTION

The object of providing a vehicular antenna in which no mutual effects are imparted even when comprising a plurality of antennas is manifested by connecting the lead wire that leads the antenna element signals to a first substrate that handles the signals that are received by the antenna element through substantially the center of a patch antenna, and by arranging the insert fitting in which the antenna element is fixed in the overhead area of the patch antenna that does not affect the patch antenna emission pattern.

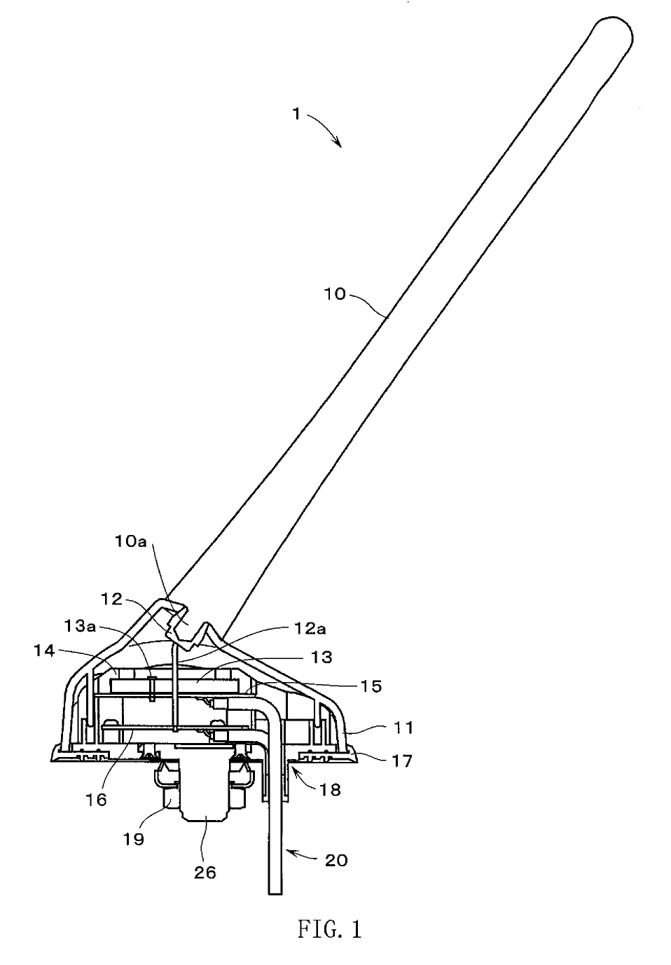

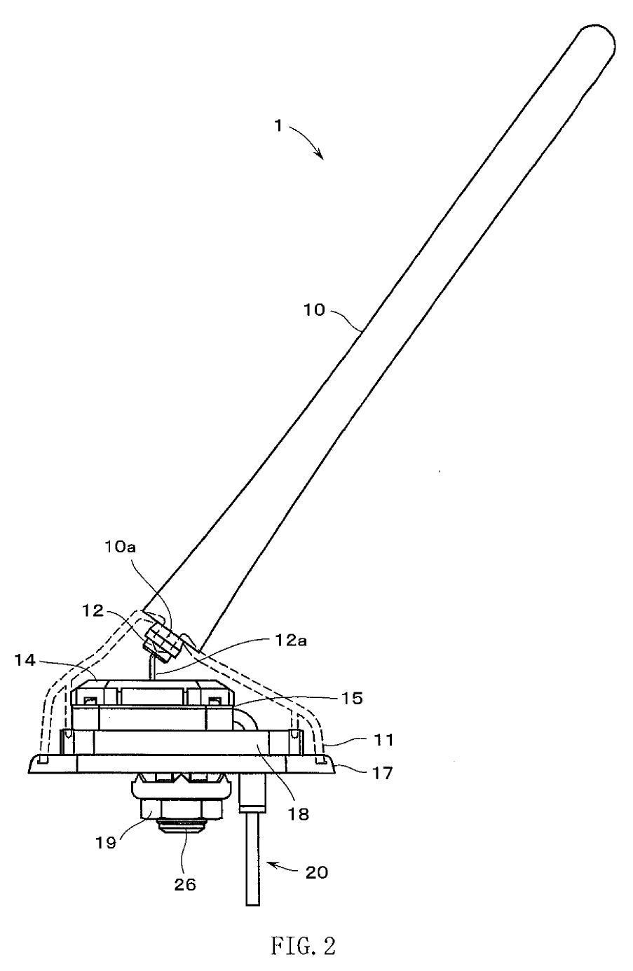

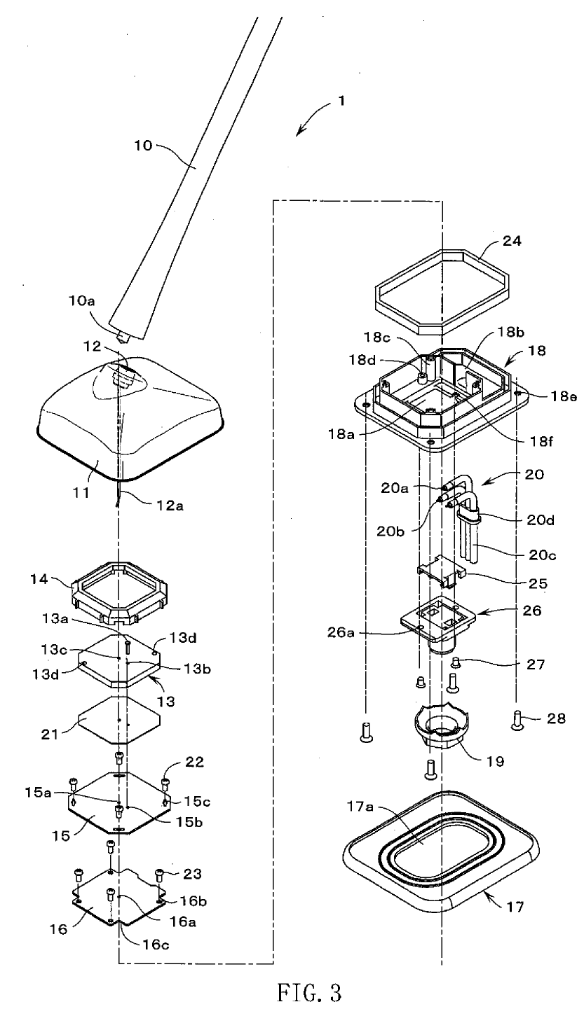

The configuration of a vehicular antenna 1 of an embodiment of the present invention is indicated in FIG. 1 to FIG. 3. FIG. 1 is a cross-sectional diagram viewed from the side indicating a configuration of a vehicular antenna 1 of an embodiment of the present invention; FIG. 2 is a side view diagram transparently indicating a part of a vehicular antenna 1 of an embodiment of the present invention; and FIG. 3 is an analytic assembly diagram of a vehicular antenna 1 of an embodiment of the present invention.

The vehicular antenna 1 of the embodiment of the present invention indicated in these diagrams has a flexible element 10, and an antenna cover 11 formed in a single unit with an insert fitting 12 to which the antenna element 10 is detachably fixed. The antenna element 10 is an antenna element that receives AM/FM broadcasts, and a helical element is housed in the interior thereof. The lower end of this helical element is electrically connected to the connecting fitting 10a, and the antenna element 10 is configured by forming an element cover comprising an elastomer such that the entire element is covered except for the lower part of the connecting fitting 10a. Further, a screw part that spirally attaches to the insert fitting 12 is formed on the lower part of the connecting fitting 10a, and the upper part of the insert fitting 12 is electrically connected to the lower part of the helical element, and is covered by an element cover.

An antenna cover 11 made of resin is formed like an upside down bowl opening to the bottom surface, and the housing space is formed in the interior thereof. Laminated and housed in the housing space of this antenna cover 11 are a patch antenna 13 that receives satellite broadcasts such as XM radio, a first substrate 15 to which the patch antenna 13 is fixed and on which the matching circuit and amplifier that amplifies the signals received by the patch antenna 13 are formed, and a second substrate 16 on which the matching circuit and amplifier that amplifies the signals received by the antenna element 10 are formed. A base fitting 18 is fixed such that the bottom of this antenna cover 11 is closed off, and a base pad 17 comprising a flexible elastomer or the like is mated to the perimeter of the base fitting 18. The patch antenna 13, the first substrate 15 and the second substrate 16 are laminated and secured to this base fitting 18. Moreover, a protruding screw part 26 for assembling the vehicular antenna 1 on the vehicle is secured to the bottom of this base fitting 18. A nut 19 with washer for securing is spirally attached to the screw part 26 with the vehicle body between. The tip of the washer on the upper part of the nut 19 with washer is formed in a wedge shape that bites into the reverse surface of the vehicle to make a mechanical bond and an electrical connection that are satisfactory.

The detailed configuration of the vehicular antenna 1 related to the present invention will be explained by describing the assembly steps of the vehicular antenna 1 while referring mainly to FIG. 3.

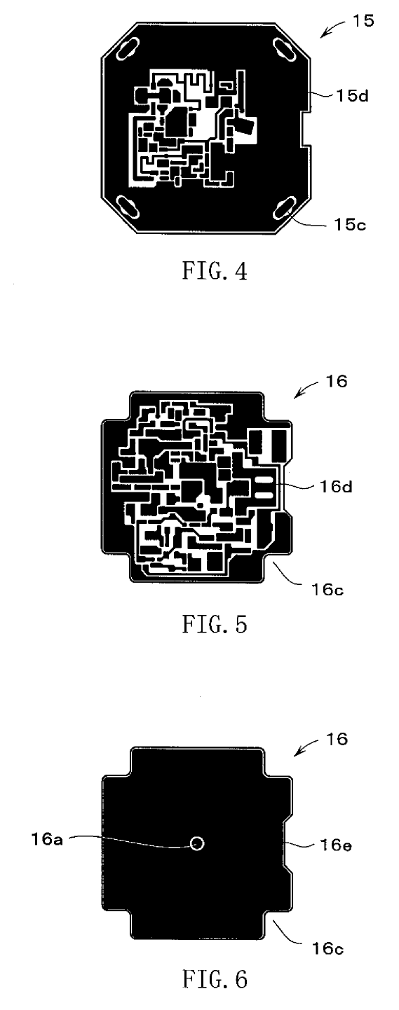

To assemble the vehicular antenna 1 related to the present invention, first the patch antenna 13 is secured to the first substrate 15 using double sided tape 21. The patch antenna 13 is comprised by using a rectangular conductive substrate having a thickness of approximately ¼ the wavelength of the electrical wave of the center frequency used and forming on the top surface thereof a circular or rectangular patch element having a perturbation element that can receive circular polarized waves. Then, the first substrate 15 is formed into a rectangle larger than the patch antenna 13 all the way around, and acts as a ground of the patch antenna 13 by grounding the full surface thereof. The configuration of the first substrate 15 is indicated in FIG. 4, and the four corners of the rectangular first substrate 15 are removed, and the screw holes 15c are formed respectively. Moreover, on the back side of the first substrate 15 is formed the back side pattern 15d for incorporating the matching circuit and amplifier that amplifies the signals received by the patch antenna 13.

An insertion through-hole 13c is formed substantially in the center part of the patch antenna 13, and a mating insertion hole 13b is formed in a stipulated position near the center part. A power feed pin 13a is inserted through this mating insertion hole 13b and is soldered to the element of the patch antenna 13; and the power feed pin 13a passes through the double-sided tape 21, is inserted and mated into a mating insertion hole 15b of the first substrate 15, and is connected by soldering to the back side pattern 15d. The reception signals that are received by the patch antenna 13 can thereby be supplied to the first substrate 15 and amplified. The amplifier incorporated into the first substrate 15 is a low noise amplifier (LNA). A first cable 20a of the cable 20 is connected by soldering to the back side pattern 15d of the first substrate 15 that has the patch antenna 13 assembled in this way. The first cable 20a is drawn into the interior of the vehicle, and leads, for example to an XM radio receiver. A second cable 20b and a third cable 20c of the cable 20 are connected to the second substrate 16.

Here, as indicated in FIG. 5, formed on the back side of the second substrate 16 is a back side pattern 16d for forming the matching circuit and amplifier to amplify the AM/FM reception signals that are received by the antenna element 10. Then, the reception signals received by the antenna element 10 are supplied to the second substrate 16 and are amplified. The amplifier incorporated into the second substrate 16 is a low noise amplifier (LNA). Moreover, as indicated in FIG. 6, the surface pattern 16e comprising a full surface ground is formed on the top surface of the second substrate 16. Further, the second substrate 16 is formed into a rectangular shape that is smaller all the way around than the first substrate 15, and the four corners formed into the rectangular notches 16c, and screw holes 16b are formed respectively. Moreover, an insertion through-hole 16a is formed in substantially the center part of the second substrate 16. The second cable 20b and third cable 20c of the cable 20 are connected by soldering to the back side pattern 16d of the second substrate 16, and the second cable 20b and the third cable 20c are drawn into the interior of the vehicle and lead to an AM/FM broadcast receiver.

The second substrate 16 with the second cable 20b and the third cable 20c connected in this way is assembled on base fittings 18 by inserting the screws 23 respectively through the screw holes 16b formed in the four corners, and spirally attaching the screws 23 respectively to the second bosses 18d formed in the base fitting 18. In this case, the second bosses 18d are formed in the space surrounded by the side walls formed upright on the upper surface of the base fitting 18, and therefore, the second substrate 16 is housed in the space surrounded by the side walls and is shielded by the top surface pattern 16e and the side walls. Next, the first substrate 15 with the first cable 20a connected is attached to the base fitting 18 by inserting the screws 22 respectively in the screw holes 15c formed at the four corners, and by spirally attaching the screws 22 respectively to the first bosses 18c formed in the base fitting 18. The second substrate 16 and the first substrate 15 to which the patch antenna 13 is secured are housed in the housing part 18a of the base fitting 18, and the cable 20 comprising the first cable 20a through third cable 20c is housed in the cable housing part 18b. Further, the cable 20 is drawn in from the cable drawing hole formed in the bottom surface of the base fitting 18 as indicated in FIG. 1 and FIG. 2. The cable drawing hole is formed in a tubular shape that protrudes downward from the bottom surface of the base fitting 18.

Next, a holder 14 made of resin formed in a rectangular frame shape is mated and installed from above the patch antenna 13, and the packing 24, which is formed into a frame shape, is inserted into a groove between the double side walls formed in the base fitting 18. Next, the lead wire 12a, which is extended to and connected with the insert fitting 12 of the antenna cover 11, is inserted in order through the insertion through-hole 13c of the patch antenna 13, the insertion through-hole 15a of the first substrate 15, and the insertion through-hole 16a of the second substrate 16. The antenna cover 11 is covered by the base fitting 18. Then, the screws 28 are inserted in the screw holes 18e formed respectively on the four corners of the base fitting 18, and the screws 28 are spirally attached respectively to the lower surface of the antenna cover 11. At that time, the lower part of the antenna cover 11 is formed into double side walls, and as indicated in FIG. 1 and FIG. 2, the tip of the interior side wall penetrates into the groove in which the packing 24 is inserted, and the upper surface of the packing 24 is pressure sealed. The antenna cover 11 and the base fitting 18 are thereby secured with a water-tight seal.

Next, the tip of the lead wire 12a that is inserted through the insertion through-hole 16a of the second substrate 16 is soldered to the signal input terminal of the back side pattern 16d of the second substrate 16. This soldering is conduced from an opening part formed in the bottom surface of the base fitting 18. The AM/FM reception signals received by the antenna element 10 are thereby fed to the second substrate 16, and are amplified.

Next, a temporary hook 25 comprising a flexible plate is assembled on the upper surface of the screw part 26, and the screw part 26 with the assembled temporary hook 25 is mated to the opening part formed on the bottom surface of the base fitting 18. A pair of opposing latch pieces that are bent from the sides facing the temporary hook 25 are formed to protrude out, and the temporary hook 25 is assembled on the screw part 26 by latching the tip parts of this latch piece that fold back into the latch holes that are formed on the upper surface of the screw part 26. Moreover, a pair of bending parts is formed on both sides of the latch piece, and when mating the screw part 26 to the opening part formed in the base fitting 18, the screw part 26 is temporarily stopped in the base fitting 18 by the bending parts elastically latching in the peripheral edge of the opening part. Then, screws 27 are inserted respectively into a pair of screw holes 26a formed opposing the peripheral edge of the screw part 26, and are spirally attached respectively to screw holes 18f formed in the base fitting 18. The screw part 26 is thereby secured to the base fitting 18.

Then, the cable 20 comprising the first cable 20a through the third cable 20c is inserted through cable holder 20d, and the cable holder 20d is inserted into and mated with the tip of the cable drawing hole formed to protrude downward from the bottom surface of the base fitting 18, and is riveted. Next, the vehicular antenna 1 related to the present invention can be assembled by mating and inserting the flexible base pad 17 made of an elastomer into the lower peripheral edge of the antenna cover 11. Then, the vehicular antenna 1 can be installed on the vehicle by inserting the screw parts 26 of the vehicular antenna 1 assembled in this way into the assembly hole formed on the roof or the like of the vehicle and spirally attaching the nut 19 with washer on the nut part 26 from the inside of the vehicle.

A characteristic configuration of the vehicular antenna 1 related to the present invention will be described next.

As previously stated, in antennas that provide a plurality of antennas as in vehicular antenna 1 related to the present invention, electromagnetic mutual coupling is produced between, for example, the patch antenna 13 and the antenna element 10 and insert fitting 12 because of the arrangement in close proximity. Specifically, normally the emission pattern and electric characteristics of the patch antenna 13 are affected because the metal conductors (antenna element 10 and insert fitting 12) are arranged in close proximity to the patch antenna 13. In the vehicular antenna 1 of the present invention, however, the effects on the emission pattern and electric characteristics of the patch antenna 13 are resolved in the following way.

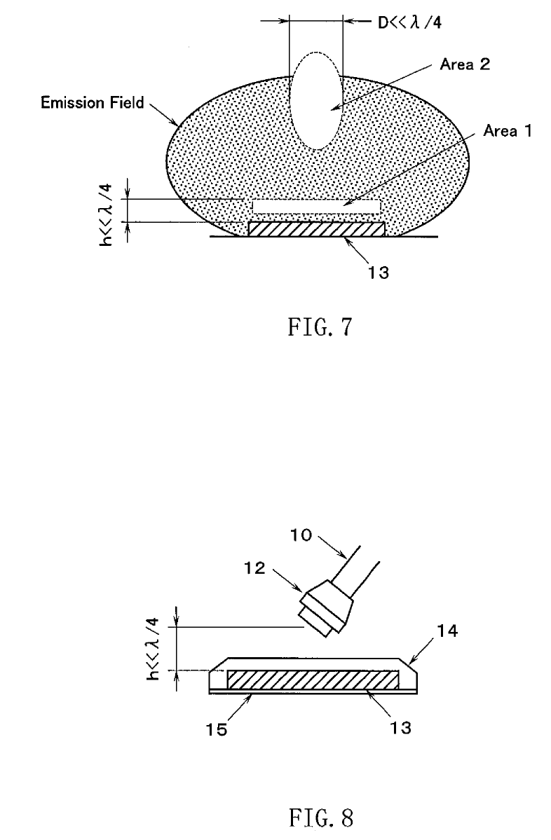

FIG. 7 is the outline of the emission field of the patch antenna 13 of the vehicular antenna 1 of the present invention. The emission field of the patch antenna 13 is formed in the space above the patch antenna 13 as indicated in the diagram, but, if we let λ be the wavelength of the use center frequency of the patch antenna 13, it is well known that, even if a metal conductor is arranged, there will be no effect on the emission pattern or the electrical characteristics of the patch antenna 13 in the area 1 indicated in FIG. 7 in which the gap h in proximity to the patch antenna 13 is h<<λ/4. Further, even if the gap h in proximity to the patch antenna 13 is not a gap that satisfies h<<λ/4, it is well known that there will be no effect on the emission pattern or the electrical characteristics of the patch antenna 13 when a metal conductor is arranged above the central part of the patch antenna 13 in the area 2 indicated in FIG. 7 having a width D that satisfies D<<λ/4.

Thus, in the vehicular antenna 1 of the present invention, the insert fitting 12 is formed in a single unit in the antenna cover 11 such that the insert fitting 12 is arranged a position of gap h wherein the gap h satisfies h<<λ/4 overhead of the patch antenna 13 as indicated in FIG. 8. Further, the width D of the insert fitting 12 and the antenna element 10 secured to the insert fitting 12 is a width D that satisfies D<<λ/4, and the insert fitting 12 and the antenna element 10 are extended at an upward slant. An effect on the emission pattern or electrical characteristics of the patch antenna 13 is thereby prevented even if the antenna element 10 and insert fitting 12, which are metal conductors, are arranged in the proximity of the patch antenna 13.

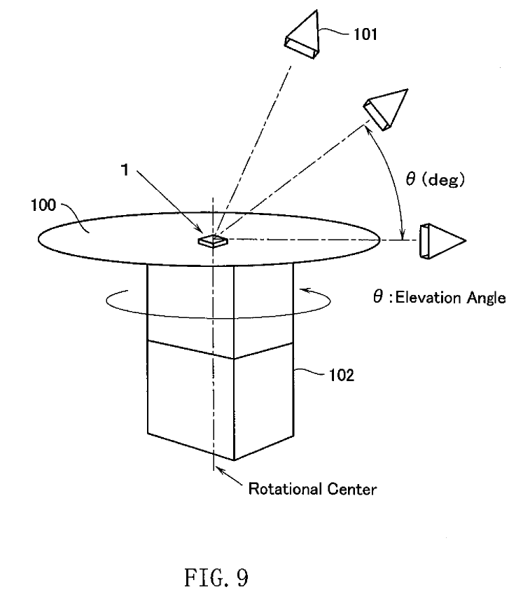

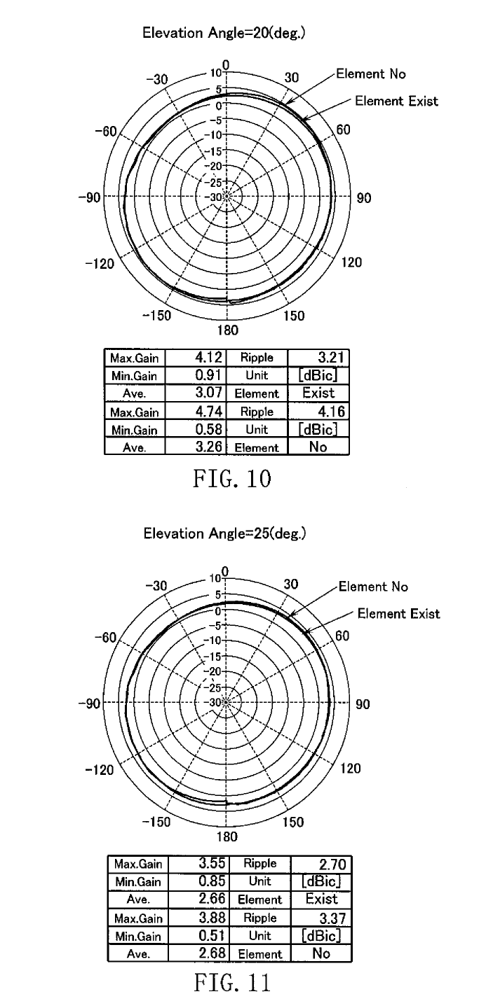

Thus, the orientation characteristics in the transverse plane of the vehicular antenna 1 related to the present invention are indicated in FIG. 10 through FIG. 18. Further, the orientation characteristics in the transverse plane were measured by setting the angle of electromagnetic wave arrival direction (elevation angle) at 5° steps from 20° to 60° from horizontal because the electromagnetic wave arrival direction to the vehicular antenna 1 is not limited to the zenith. A schema of the measurement system is indicated in FIG. 9. As indicated in FIG. 9, the vehicular antenna 1 related to the present invention is mounted on a circular base plate 100, which is considered infinitely larger than the projection surface area of the vehicular antenna 1, and a support unit 102 of the base plate 100 can rotate 360° within the horizontal plane with the rotational center as the axis. A transmission side antenna 101, which imitates a broadcast satellite such as a XM radio, is arranged at a position from horizontal to the zenith of angle θ (elevation angle). The orientation characteristics within the transverse plane with and without the antenna element 10 and the insert fitting 12 in the vehicular antenna 1 were measured using the same angle θ (elevation angle). In FIG. 10 through FIG. 18, the orientation characteristics within the transverse plane with the elements are indicated as “Element Exist” and those without as “Element No”. Further, antenna element 10 is omitted in FIG. 9.

FIG. 10 is the orientation characteristics within the transverse plane of vehicular antenna 1 when the elevation angle was set at θ=20°. The maximum gain of these orientation characteristics within the transverse plane when the antenna element 10 and the insert fitting 12 were present (Element Exist) was 4.12 dBic, and the minimum gain was 0.91 dBic. The maximum gain when antenna element 10 and insert fitting 12 were not present (Element No) was 4.74 dBic, and the minimum gain was 0.58 dBic. Referring to FIG. 10, the average gain (Ave.) with Element Exist was slightly lower, but the axial ratio (Ripple) was improved; and the antenna element 10 and the insert fitting 12 had hardly any effect on the patch antenna 13. Further, dBic is a unit of antenna gain which uses a non-oriented antenna that emits circular polarized waves as the standard.

FIG. 11 is the orientation characteristics within the transverse plane of vehicular antenna 1 when the elevation angle was set at θ=25°. The maximum gain of these orientation characteristics within the transverse plane when the antenna element 10 and the insert fitting 12 were present (Element Exist) was 3.55 dBic, and the minimum gain was 0.85 dBic. The maximum gain when antenna element 10 and insert fitting 12 were not present (Element No) was 3.88 dBic, and the minimum gain was 0.51 dBic. Referring to FIG. 11, the average gain (Ave.) with Element Exist was slightly lower, but the axial ratio (Ripple) was improved; and the antenna element 10 and the insert fitting 12 had hardly any effect on the patch antenna 13. Further, compared to when θ=20°, the average gain (Ave.) was slightly lower, but the axial ratio (Ripple) was slightly improved.

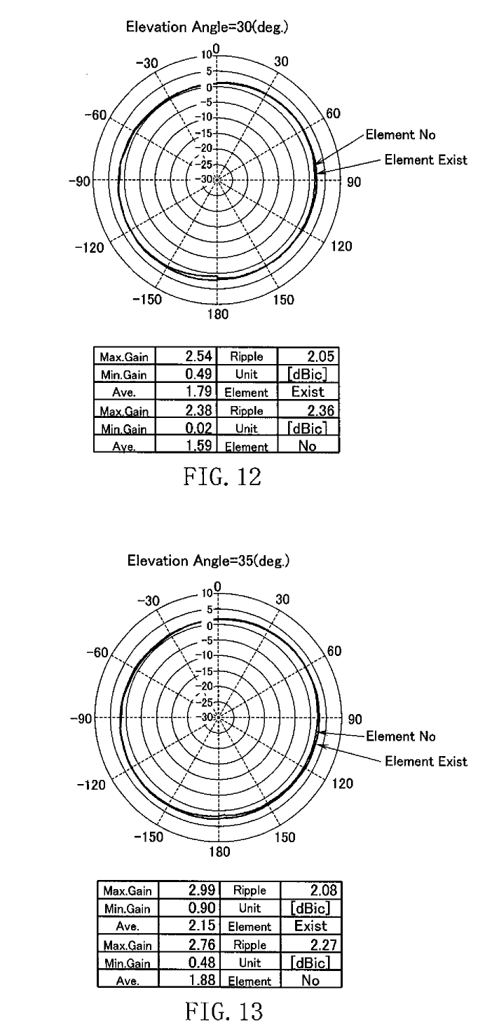

FIG. 12 is the orientation characteristics within the transverse plane of vehicular antenna 1 when the elevation angle was set at θ=30°. The maximum gain of these orientation characteristics within the transverse plane when the antenna element 10 and the insert fitting 12 were present (Element Exist) was 2.54 dBic, and the minimum gain was 0.49 dBic. The maximum gain when antenna element 10 and insert fitting 12 were not present (Element No) was 2.38 dBic, and the minimum gain was 0.02 dBic. Referring to FIG. 12, the average gain (Ave.) with Element Exist was improved, and the axial ratio (Ripple) was improved; and the antenna element 10 and the insert fitting 12 had hardly any effect on the patch antenna 13. Further, compared to when θ=25°, the average gain (Ave.) was lower, but the axial ratio (Ripple) was improved.

FIG. 13 is the orientation characteristics within the transverse plane of vehicular antenna 1 when the elevation angle was set at θ=35°. The maximum gain of these orientation characteristics within the transverse plane when the antenna element 10 and the insert fitting 12 were present (Element Exist) was 2.99 dBic, and the minimum gain was 0.90 dBic. The maximum gain when antenna element 10 and insert fitting 12 were not present (Element No) was 2.76 dBic, and the minimum gain was 0.48 dBic. Referring to FIG. 13, the average gain (Ave.) with Element Exist was improved, and the axial ratio (Ripple) was improved; and the antenna element 10 and the insert fitting 12 had hardly any effect on the patch antenna 13. Further, compared to when θ=30°, the average gain (Ave.) was improved, but the axial ratio (Ripple) was slightly lower.

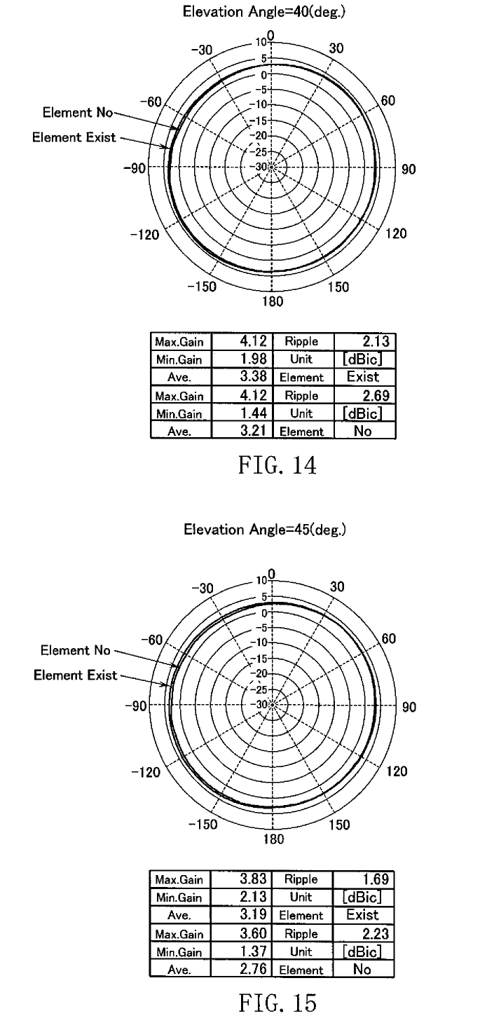

FIG. 14 is the orientation characteristics within the transverse plane of vehicular antenna 1 when the elevation angle was set at θ=40°. The maximum gain of these orientation characteristics within the transverse plane when the antenna element 10 and the insert fitting 12 were present (Element Exist) was 4.12 dBic, and the minimum gain was 1.98 dBic. The maximum gain when antenna element 10 and insert fitting 12 were not present (Element No) was 4.12 dBic, and the minimum gain was 1.44 dBic. Referring to FIG. 14, the average gain (Ave.) with Element Exist was improved, and the axial ratio (Ripple) was improved; and the antenna element 10 and the insert fitting 12 had hardly any effect on the patch antenna 13. Further, compared to when θ=35°, the average gain (Ave.) was vastly improved, but the axial ratio (Ripple) was slightly lower.

FIG. 15 is the orientation characteristics within the transverse plane of vehicular antenna 1 when the elevation angle was set at θ=45°. The maximum gain of these orientation characteristics within the transverse plane when the antenna element 10 and the insert fitting 12 were present (Element Exist) was 3.83 dBic, and the minimum gain was 2.13 dBic. The maximum gain when antenna element 10 and insert fitting 12 were not present (Element No) was 3.60 dBic, and the minimum gain was 1.37 dBic. Referring to FIG. 15, the average gain (Ave.) with Element Exist was improved, and the axial ratio (Ripple) was improved; and the antenna element 10 and the insert fitting 12 had hardly any effect on the patch antenna 13. Further, compared to when θ=40°, the average gain (Ave.) was slightly lower, but the axial ratio (Ripple) was improved.

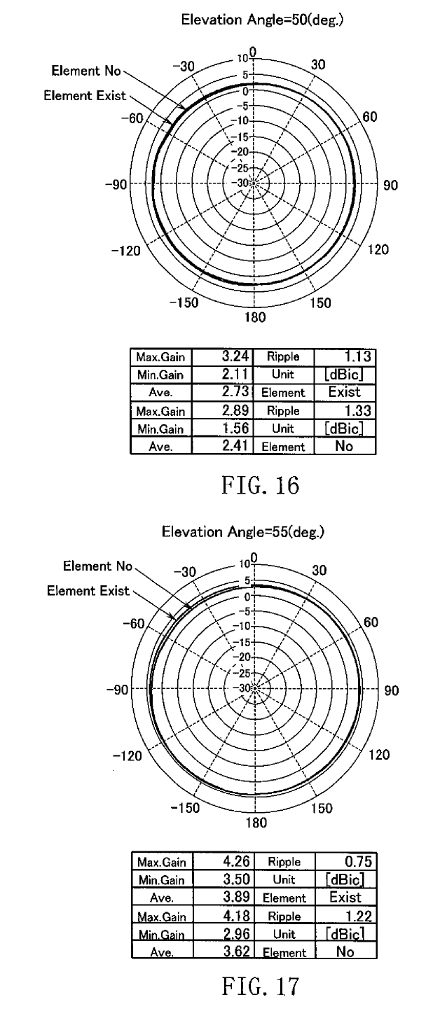

FIG. 16 is the orientation characteristics within the transverse plane of vehicular antenna 1 when the elevation angle was set at θ=50°. The maximum gain of these orientation characteristics within the transverse plane when the antenna element 10 and the insert fitting 12 were present (Element Exist) was 3.24 dBic, and the minimum gain was 2.11 dBic. The maximum gain when antenna element 10 and insert fitting 12 were not present (Element No) was 2.89 dBic, and the minimum gain was 1.56 dBic. Referring to FIG. 16, the average gain (Ave.) with Element Exist was improved, and the axial ratio (Ripple) was improved; and the antenna element 10 and the insert fitting 12 had hardly any effect on the patch antenna 13. Further, compared to when θ=45°, the average gain (Ave.) was slightly lower, but the axial ratio (Ripple) was improved.

FIG. 17 is the orientation characteristics within the transverse plane of vehicular antenna 1 when the elevation angle was set at θ=55°. The maximum gain of these orientation characteristics within the transverse plane when the antenna element 10 and the insert fitting 12 were present (Element Exist) was 4.26 dBic, and the minimum gain was 3.50 dBic. The maximum gain when antenna element 10 and insert fitting 12 were not present (Element No) was 4.18 dBic, and the minimum gain was 2.96 dBic. Referring to FIG. 17, the average gain (Ave.) with Element Exist was improved, and the axial ratio (Ripple) was improved; and the antenna element 10 and the insert fitting 12 had hardly any effect on the patch antenna 13. Further, compared to when θ=50°, the average gain (Ave.) was vastly improved, and the axial ratio (Ripple) was improved.

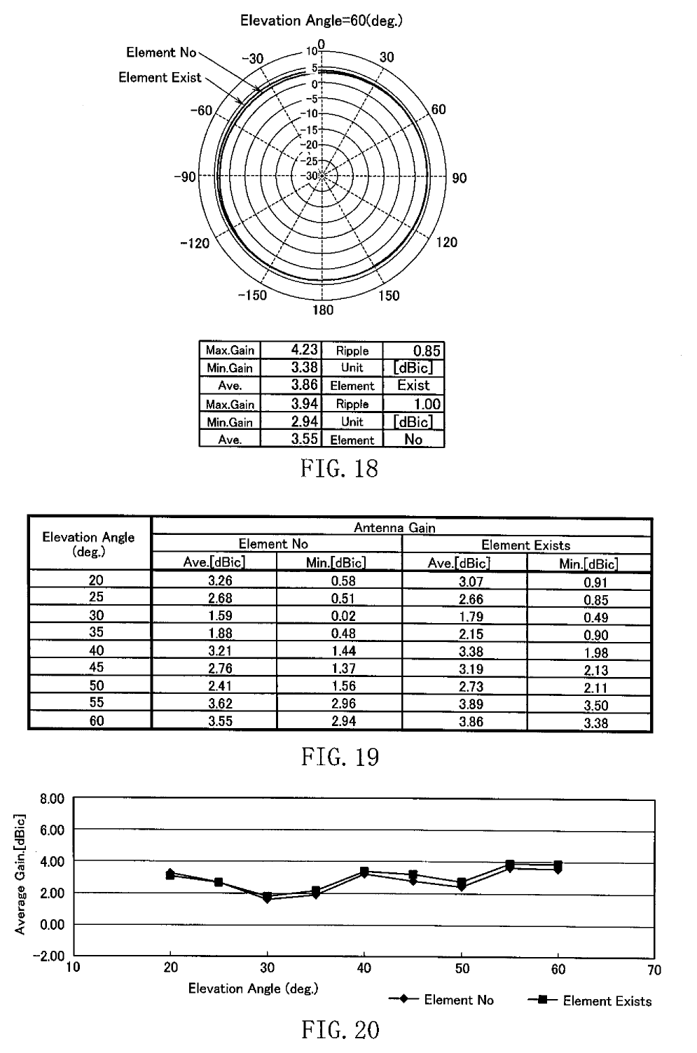

FIG. 18 is the orientation characteristics within the transverse plane of vehicular antenna 1 when the elevation angle was set at θ=60°. The maximum gain of these orientation characteristics within the transverse plane when the antenna element 10 and the insert fitting 12 were present (Element Exist) was 4.23 dBic, and the minimum gain was 3.38 dBic. The maximum gain when antenna element 10 and insert fitting 12 were not present (Element No) was 3.94 dBic, and the minimum gain was 2.94 dBic. Referring to FIG. 18, the average gain (Ave.) with Element Exist was improved, and the axial ratio (Ripple) was improved; and the antenna element 10 and the insert fitting 12 had hardly any effect on the patch antenna 13. Further, compared to when θ=55°, the average gain (Ave.) and the axial ratio (Ripple) were substantially equivalent.

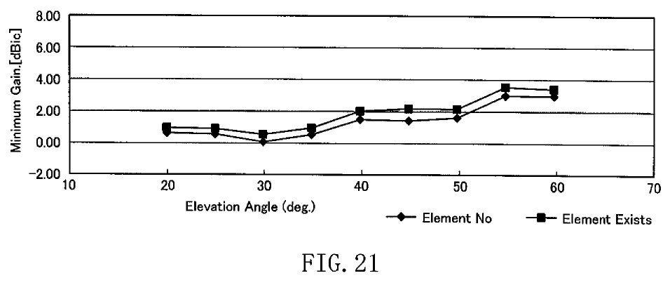

The table shown in FIG. 19 indicates the changes in the average gain (Ave.) and minimum gain (Min.) when varying the elevation angle θ in the range of 20° to 60° in antennas with (Element Exist) and without (Element No) the antenna element 10 and the insert fitting 12. Moreover, FIG. 20 is a graph indicating the changes of average gain (Ave.) when varying the elevation angle θ in the range of 20° to 60° in antennas with (Element Exist) and without (Element No) the antenna element 10 and the insert fitting 12; and FIG. 21 is a graph indicating the changes of minimum gain (Min.) when varying the elevation angle θ in the range of 20° to 60° in antennas with (Element Exist) and without (Element No) the antenna element 10 and the insert fitting 12.

As indicated in these diagrams, the average gain (Ave.) and the minimum gain (Min.) tended to improve as the elevation angle θ became larger. Moreover, the axial ratio (Ripple) also became more satisfactory as the elevation angle θ became larger, as indicated in FIGS. 10 to 18.

As explained above, in the vehicular antenna 1 of the present invention, the antenna element 10 is secured to the insert fitting 12 such that this insert fitting 12 is arranged in a location overhead of the patch antenna 13 with a gap h that satisfies h<<λ/4 as indicated in FIG. 8. An effect on the emission pattern and electric characteristics of the patch antenna 13 can thereby be prevented even if the antenna element 10 and insert fitting 12, which are metal conductors, are set up in proximity to the patch antenna 13.

### INDUSTRIAL APPLICABILITY

A Patch antenna that receives satellite broadcasts such as XM radio was described above, but the present invention is not limited to this, and may be used as a patch antenna for GPS or for bands of several GHz.

1. A vehicular antenna comprising:
an antenna element comprising a connecting fitting on the lower end;
an insulative antenna cover, in which an insert fitting to which the connecting fitting of said antenna element is detachably fixed is integrally formed with the upper portion thereof, the lower end of the insulative antenna cover being open so that a housing space is formed in the interior thereof;
a base fitting that is secured so that the lower surface of said antenna cover is closed off;
a first substrate that is housed in the housing space of said antenna cover by being secured to said base fitting, and on which a high frequency circuit that handles signals received by said antenna element is formed; and
a second substrate that is laminated on the top of said first substrate and is housed in the housing space of said antenna cover by being secured to said base fitting, and on which a high frequency circuit that handles signals received by a patch antenna secured to the upper surface is formed; wherein
one end of a lead wire, which leads signals of said antenna element and of which the other end is connected to said insert fitting, passes through substantially the centers of said patch antenna and said second substrate, and is connected to said first substrate, and said insert fitting is arranged in the overhead area of said patch antenna that does not affect the emission pattern of said patch antenna.

2. The vehicular antenna according to claim 1 wherein, when taking the use center frequency of said patch antenna to be λ, said insert fitting is arranged on the central area of said patch antenna so that the size D of said insert fitting satisfies D<<λ/4.

3. The vehicular antenna according to claim 1 wherein, when taking the use center frequency of said patch antenna to be λ, said insert fitting is arranged so that the gap h between said insert fitting and said patch antenna satisfies h<<λ/4.

4. The vehicular antenna according to claim 1, wherein said second substrate is secured in the space surrounded by side wall parts formed upright on said base fitting, and the full surface of said second substrate on the first substrate side is formed into a ground, to shield the second substrate.
